(19) United States
(12) Patent Application Publication
(10) Pub. No.: US 2002/0180134 A1
(43) Pub. Date: Dec. 5, 2002

(54) Yaeger third hand vise

(76) Inventor: William J. Yaeger, Helena, MT (US)

Correspondence Address: HOOVESTAL & KAKUK, PLLC, 40 W. 14TH ST., P.O. BOX 747, HELENA, MT, 59624, US

(21) Appl. No.: 10/161,888

(22) Filed: Jun. 4, 2002

Related U.S. Application Data
(60) Provisional application No. 60/296,207, filed on Jun. 4, 2001.

(51) Int. Cl. B25B 1/24

(52) U.S. Cl. 269/271

(57) ABSTRACT

The present invention relates to a means for attaching a pair of pliers to a vise for holding a workpiece. The vise includes at least one set of two receptacles. Each receptacle being designed and placed to hold one handle of a standard pair of pliers. As the vise jaws are adjusted, the pliers jaws are also adjusted thereby allowing an individual to quickly, securely, and safely hold an article while working on that article with both hands.

### CROSS REFERENCE TO RELATED APPLICATIONS

This application claims the benefit of a Provisional Patent Application, Application No. 60/296,207, filing date of Jun. 4, 2001.

### BACKGROUND OF THE INVENTION

Often, when an individual wishes to work with a small or delicate article, the individual must hold the article in one hand while working on the article with the other. This obviously precludes working on the article with both hands. Usually, using both hands would make the work proceed in a more efficient and effective manner. In other words, often when working on a small or delicate article, the individual needs a “third hand”.

There are products currently on the market that may act as a clamping device or other “third hand” attachment to a vise, but utilizing these attachments requires that you must then remove that attachment before using the vise in a standard fashion. Also, these attachments can be expensive, difficult to operate, and can be themselves delicate or fragile.

Patent searches using the terms “vise” and “attachment” and “vise” and “pliers” revealed nothing that resembled the disclosed invention. Therefore, there is no vise on the market, or for which a patent has been granted, that allows a user to quickly, securely, and safely hold a small or delicate article on a vise while at the same time allowing the individual to use the vise in a standard manner.

### BRIEF SUMMARY OF THE INVENTION

The Yaeger Third Hand Vise overcomes the above-described problems by providing a vise that readily accepts a standard pair of pliers. The pliers then serve as the necessary “third hand” when working with small or delicate articles.

The Third Hand Vise operates as follows:

Each of the two vise jaws has at least one hole or receptacle;

Such receptacle is designed and placed in correlation to the other receptacle to accept one of the two handles of a standard pair of pliers;

As the distance between the vise jaws is adjusted, so the distance between the pliers jaws is adjusted; and

When the individual no longer has a need for the pliers, the individual simply removes the pliers from the receptacles and proceeds to use the vise in a normal manner.

A typical use of the vise attachment may include:

Adjusting the distance between the vise jaws to allow the placement of a handle of a standard pair of pliers into a receptacle on each vise jaw;

Placing a standard pair of pliers into said receptacles;

Adjusting the vise jaws until the pliers jaws are the proper distance to hold the desired article.

The device will be of use to anyone who needs to hold a small or delicate article in place while working on that article with both hands.

### BRIEF DESCRIPTION OF THE SEVERAL VIEWS OF THE DRAWINGS

FIG. 1 shows a standard vise with a set of vertical receptacles (FIG. 1A) and a set of horizontal receptacles (FIG. 1B)

### DETAILED DESCRIPTION OF THE INVENTION

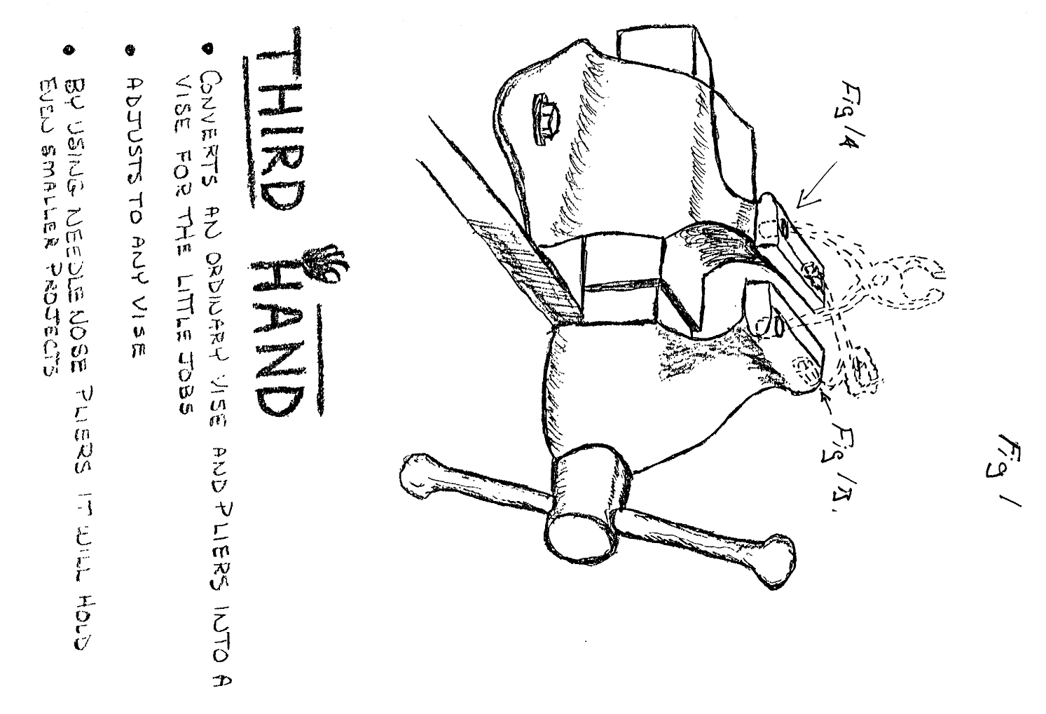

With reference now to the FIG. 1, the preferred embodiment of the new “Third Hand” Vise comprises a plurality of components. In their broadest context, such components include:

a bench vise including;

two jaws, the distance between each jaw being adjustable;

at least one set of two receptacles, each receptacle designed and placed in correlation to the other receptacle to accept one handle of a pair of standard pliers; and

each receptacle being drilled directly into each one of two vise jaws.

Such components are individually configured and correlated with respect to each other to provide a means for attaching a pair of pliers to a bench vise in such a manner that by adjusting the distance between the jaws of the vise also adjusts the distance between the jaws of the pliers. The receptacles may also be drilled into the vise jaws to allow for either vertical or horizontal attachment of the pliers to the vise.

I claim:

1. a means of attaching a pair of pliers to a standard vise the means comprising of:
a vise with two jaws, the distance between the jaws being adjustable;
at least one set of two receptacles, each receptacle designed and placed in correlation to the other receptacle to accept one handle of a pair of standard pliers; and
each receptacle being drilled directly into each one of two vise jaws.

2. the apparatus claimed in claim 1 above where the receptacles are drilled vertically into each vise jaw from the top of each jaw.

3. the apparatus claimed in claim 1 above where the receptacles are drilled horizontally into each vise jaw from the same side of each jaw.

4. the apparatus claimed in claim 1 above where there are two sets of receptacles, one set being drilled vertically into each vise jaw from the top of each jaw, and one set being drilled horizontally into each vise jaw from the same side of each jaw.

5. the apparatus claimed in claim 1 above where there are three sets of receptacles, one set being drilled vertically into each vise jaw from the top of each jaw, one set being drilled horizontally into each vise jaw from the left side of each jaw, and one set being drilled horizontally into each vise jaw from the right side of each jaw.
